(19) United States
(12) Patent Application Publication
(10) Pub. No.: US 2026/0219555 A1
(43) Pub. Date: Jul. 30, 2026

(54) STUMP-CAMERA ASSEMBLY

(71) Applicant: Mihir Jaykant Mehta, Milton Keynes (GB)

(72) Inventor: Mihir Jaykant Mehta, Milton Keynes (GB)

(21) Appl. No.: 19/039,777

(22) Filed: Jan. 28, 2025

(51) Int. Cl. G03B 17/04; A63B 69/00

(52) U.S. Cl. CPC G03B 17/04; A63B 69/0015; A63B 2220/806

(57) ABSTRACT

A stump-camera assembly comprising: three linearly coaxial parts being: an operative upper part (10a); an operative middle part (10b); an operative lower part (10c); a cylindrical casing (10d) ensconced within, and co-axial to, said operative middle part (10b) in order to reinforce said operative middle part (10b), said cylindrical casing (10d) having: an operative upper portion (10d.1) which houses an imaging assembly (20); an operative upper lower (10d.2) which houses a battery/power bank (22); a first hole (11a), in the operative middle part (10d), which exposes the imaging assembly's (20) lens made in the casing (10d) such that the lens is placed slightly behind the hole (11a) to avoid any lens impact damage; and a second hole (11b), in the operative middle part (10d), which secures the imaging assembly (20) to the casing (10d).

### FIELD

The invention relates to the technical field of wastewater treatment. More particularly, the invention relates to a system and regenerable molecular media for wastewater purification treatment and a preparation method thereof. This invention relates to the field of sports equipment. Particularly, this invention relates to a stump-camera assembly

### BACKGROUND

In the field of cricket sports, prior art stumps use a camera which is located quite low. Due to this, the field of vision is restriction.

This prior art setup requires fitting of camera onto the stump, creating internal holes for wiring to pass through, and passing the wiring, that is hardwired, onto a transmitter box which is which is placed inside a hole that is dug right behind the wickets. In this prior art setup, receivers are placed just outside boundary lines such that they receive video feed from the transmitter which is then passed on for further processing.

The low fitting of the camera has a very limited viewing angle; i.e., typically, between 50 degrees and 128 degrees. In practice, it is only used for viewing just the popping crease. The main use, of this prior art setup, is limited to getting clear angles for stumping/runout decisions in front of the stump.

This sort of the prior art setup needs the ground to have the hole dug right behind the wicket which incurs maintenance costs too. This setup is only possible at an international level and is not affordable at a grassroot level and at club grounds.

According to prior art, imaging assemblies (such as cameras) continued to be placed at lower heights for one or more of the following reasons:
1) placement of the camera higher up defeats purposes of focusing on popping crease;
2) higher the camera, larger is the need for drilling holes through the stump for the supporting wiring - more the holes in the stump means the tensile strength of the stump is reduced making it vulnerable to breakages on high impact;
3) probability of a ball hitting the stump, at higher speeds, towards an upper portion of stumps, during a game, is much higher than it hitting lower portions of stumps; this not just includes bowlers'bowling hitting the stumps but also includes throws coming in from fielders toward the stumps. There have been instances where the camera lenses have been damaged during the game due to the high impact of the balls hitting them. The cost of replacing a stump camera is exorbitant.

### SUMMARY

There is, therefore, a need for a stump-camera assembly which solved aforementioned problems.

An object of the invention is to provide a stump-fitted-imaging which raises the field-of-vision angle to more than 150 degrees.

Another object of the invention is to provide a wireless stump-fitted-imaging assembly.

According to this invention, there is provided a stump-camera assembly comprising:
three linearly coaxial parts, each part configured to be engaged with its adjacent part by means of threading, the parts being:
   an operative upper part;
   an operative middle part;
   an operative lower part;
a cylindrical casing ensconced within, and co-axial to, said operative middle part in order to reinforce said operative middle part, said cylindrical casing (10d) having:
   an operative upper portion which houses an imaging assembly;
   an operative upper lower which houses a battery/power bank;
   a first hole, in the operative middle part, which exposes the imaging assembly's lens made in the casing such that the lens is placed slightly behind the hole to avoid any lens impact damage; and

a second hole, in the operative middle part, which secures the imaging assembly to the casing.

In at least an embodiment, cylindrical casing is a metal casing.

In at least an embodiment, the operative upper part is 2.5 inches long with a further 1 inch of fastening at its operative bottom that joins with the operative middle metal part at its operative top.

In at least an embodiment, the operative middle part is 10 inches long with a threaded operative top and a threaded operative bottom end to fit the operative top part and the operative bottom operative part.

In at least an embodiment, the operative lower part is 15.5 inches with a further 1 inch of fastening on its operative top that joins the operative middle part at its operative bottom.

In at least an embodiment, each part is affixed to the other part by means of threaded couplings.

In at least an embodiment, operative middle part houses the casing which houses the imaging assembly and the battery/power bank.

In at least an embodiment,
a first axis of said imaging assembly passing through a central axis of said cylindrical casing; and
a second axis of said imaging assembly being perpendicular to said first axis, the second axis being coaxial to said first hole's transverse central axis.

### BRIEF DESCRIPTION OF THE ACCOMPANYING DRAWINGS

The invention will now be described in relation to the accompanying drawings, in which:

FIGS. 1a and 1b illustrates stump dimensions;

FIG. 2 illustrates a stump assembly according to this invention;

FIG. 3 illustrates a stump assembly according to this invention;

FIG. 4 illustrates a stump assembly according to this invention—showing its various parts;

FIG. 5 illustrates an exploded view of the stump assembly according to this invention - showing its various parts;

FIG. 6 illustrates a view, with components, of the operative middle part of the stump assembly;

FIG. 7 illustrates a view, with components, of the entire stump assembly, of this invention;

FIG. 8 illustrates a field of view of prior art's stump assembly where the camera is at a lower portion of the stumps; and

FIG. 9 illustrates a field of view of current invention's stump assembly where the camera is at a higher portion of the stumps.

### DETAILED DESCRIPTION

According to this invention, there is provided a stump-camera assembly.

According to prior art, stumps are made of wood and height of each stump is 28 inches according to cricket rulebook.

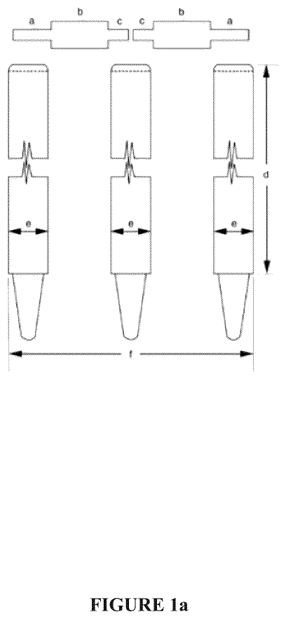

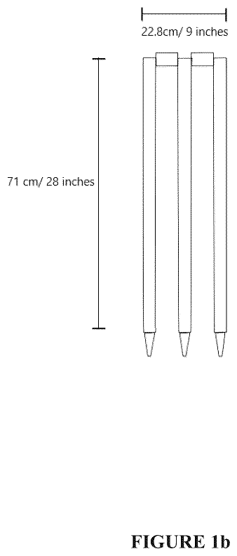

FIGS. 1a and 1b illustrates stump dimensions.

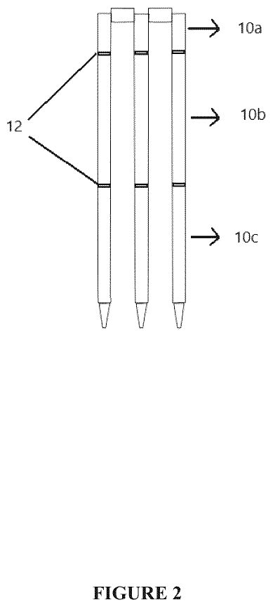

FIG. 2 illustrates a stump assembly according to this invention.

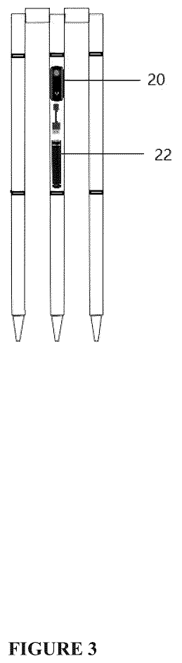

FIG. 3 illustrates a stump assembly according to this invention.

In at least an embodiment, at least one stump, from a set of stumps on one side of a pitch, is configured to made of three linearly coaxial parts, the parts being:
an operative upper part (10a);
an operative middle part (10b);
an operative lower part (10c).

Each part is configured to be engages with its adjacent part by means of threading (12a, 12b); thereby, making this system modular.

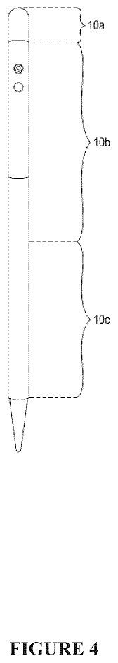

FIG. 4 illustrates a stump assembly according to this invention—showing its various parts.

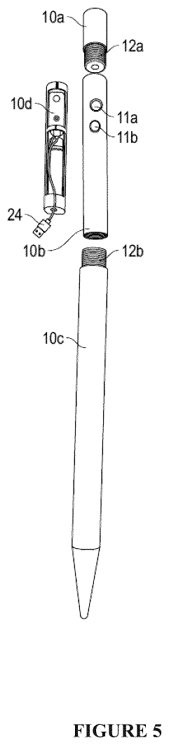

FIG. 5 illustrates an exploded view of the stump assembly according to this invention - showing its various parts.

In at least an embodiment, the operative middle part (10b) is ensconced with a co-axial cylindrical casing (10d) which reinforces the operative middle part (10b). The cylindrical casing (10d) has an operative upper portion (10d.1) which houses the imaging assembly (20) (camera, battery, wireless transmitter, and the like). The cylindrical casing (10d) has an operative upper lower (10d.2) which houses the battery/power bank (22). Reference numeral 24 refers to cables which connect the imaging assembly (12) to the battery/power bank (22) and to external power sources for charging.

Preferably, the cylindrical casing (10d) is a metal casing.

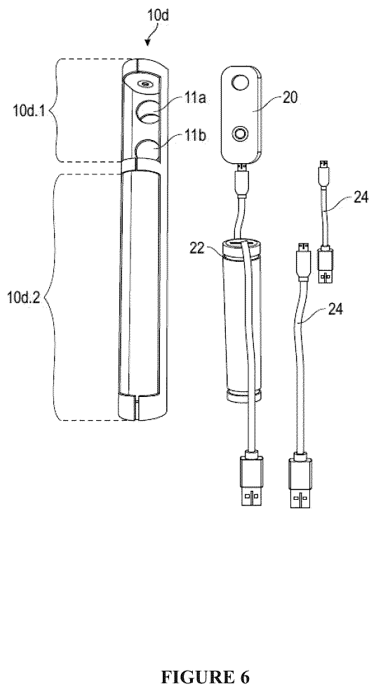

FIG. 6 illustrates a view, with components, of the operative middle part (10b) of the stump assembly.

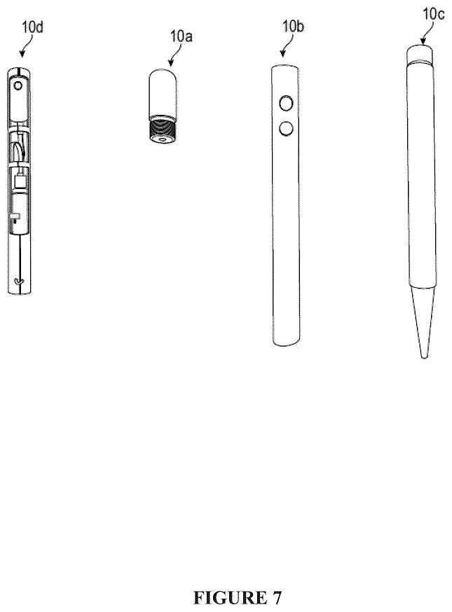

FIG. 7 illustrates a view, with components (10a, 10b, 10c, 10d), of the entire stump assembly, of this invention.

Preferably, the operative upper part (10a) is 2.5 inches long with a further 1 inch of fastening at the bottom that joins with the operative middle metal part (10b) at its top.

Preferably, the operative middle part (10b) is 10 inches long with threaded top and bottom ends to fit the top and bottom operative parts 10a and 10c.

Preferably, the operative lower part (10c) is 15.5 inches with a further 1 inch of fastening on top that joins the operative middle metal part (10b) at its bottom.

Preferably, each part is affixed to the other part by means of threaded couplings (12a, 12b) or the like fastening mechanisms.

Typically, a first hole (11a), in the operative middle part (10d), which exposes the imaging assembly's (20) lens is made in the casing (10d) such that the lens is placed slightly behind the hole to avoid any lens impact damage.

Typically, a second hole (11b), in the operative middle part (10d), which secures the imaging assembly (20) to the casing (10d).

In at least an embodiment,
a first axis of said imaging assembly (20) passes through a central axis of said cylindrical casing (10d); and
a second axis of said imaging assembly (20) is perpendicular to said first axis, the second axis being coaxial to said first hole's (11) transverse central axis.

In order to achieve the wireless setup, there is a need to house a battery/power bank (22) within the stump assembly itself. The operative middle part (10b) houses a casing (10d) which houses the imaging assembly (20) and the battery/power bank (22). This would mean the imaging assembly (20) and the battery/power bank (22) that is driving it need to be removed at some point for charging. Hence, modularity in the stump assembly is required. This is achieved by:
charging leads from within the stump does directly into a charger-so that a user does not need to remove the imaging assembly and battery/power bank, charge them after use and no need to go through the effort of fixing it back on the stump;
just separating the middle part from the bottom part would expose a charging lead that can then be connected to a charging point-this means the casing that houses the imaging assembly and the battery/power bank never needs to be removed/disturbed.

Due to this invention, the camera is placed relatively higher up; thereby, allowing imaging/capturing images over a relatively wider field of view of about 155 degrees. This setup not only captures the popping crease, but also captures the batsman's footwork, bowlers run and bowling, any fielders within the field of view and also the clear full view of the pitch.

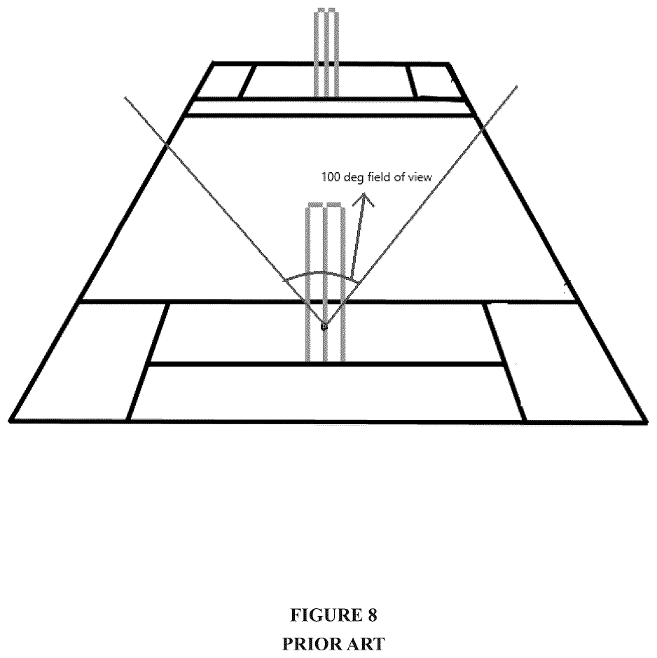

FIG. 8 illustrates a field of view (100-degree field of view) of prior art's stump assembly where the camera is at a lower portion of the stumps

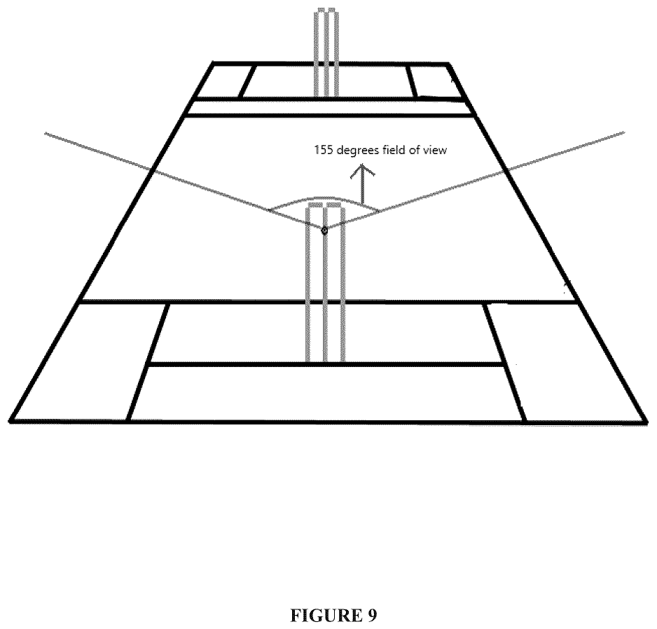

FIG. 9 illustrates a field of view of current invention's (155-degree field of view) stump assembly where the camera is at a higher portion of the stumps. In order to get to this high stance position, in a robust manner, and to ensure that the imaging and transmitting apparatus of this invention does not damage, the invention's four-part assembly of stumps is necessitated.

Due to this invention, the wiring and cabling need for a transmitter box to be placed in a hole in the ground behind the stumps is relegated. The imaging assembly, according to this invention, is a wireless assembly; without the need of any receivers. The videos can be accessed on a mobile phone within 10 m distance of the camera or via removal of the memory card stored in the video camera for processing/viewing/relaying. Cabling costs, thus, get eliminated.

TECHNICAL ADVANTAGES: removal and insertion of components of the imaging assembly becomes simple; charging becomes simple; camera, and stump, remain secure on ball impact because of the middle metal component for housing; no holes, per se, are required to be drilled; thus, tensile strength, and integrity, of stumps remains intact; and with the higher placement of the camera, it provides a bigger field of view and hence can be used in many use cases - For coaches during training, in club cricket to view footage in front of the wickets, introducing DRS at club cricket level which is currently inexistent due to infrastructure and cost issues and, at higher levels too to view the footage for various reasons like analyzing batting or bowling patterns, reading and understanding the opponents game, and to observe our own game as well. The issues of the reduction of the tensile strength of the stump due to the holes drilled for the placement of the camera and the damaging factor of the camera has been taken care of with the design of the stump.

The TECHNICAL ADVANCEMENT, of this invention, lies in modularizing a stump into 3 constituent parts and 1 inner casing part. This configuration:
protects the stump from ball's impact—thereby, securing the imaging assembly (20) placed inside the stump;
does not move/affect the imaging assembly (20) at all;
completely engulfs and ensconces the imaging assembly (20);
allows change of imaging assembly (20) with ease;
allows change of battery/power bank (22) with ease;
secures battery/power bank (22) inside the stump itself;
reins in extreme modularity even while increasing sturdiness;
no wiring is exposed;
helps to achieve Decision Review System, in an inexpensive manner, because of the vantage point.

The TECHNICAL ADVANCEMENT of this invention lies in providing an imaging setup, configured to be fitted within stumps, so as to provide an improved, and larger, field of view; in a wireless configuration.

While this detailed description has disclosed certain specific embodiments for illustrative purposes, various modifications will be apparent to those skilled in the art which do not constitute departures from the spirit and scope of the invention as defined in the following claims, and it is to be distinctly understood that the foregoing descriptive matter is to be interpreted merely as illustrative of the invention and not as a limitation.

1. A stump-camera assembly comprising:
three linearly coaxial parts, each part configured to be engaged with its adjacent part by means of threading (12a, 12b), the parts being:
an operative upper part (10a);
an operative middle part (10b);
an operative lower part (10c);
a cylindrical casing (10d) ensconced within, and co-axial to, said operative middle part (10b) in order to reinforce said operative middle part (10b), said cylindrical casing (10d) having:
an operative upper portion (10d1) which houses an imaging assembly (20);
an operative upper lower (10d2) which houses a battery/power bank (22);
a first hole (11a), in the operative middle part (10d), which exposes the imaging assembly's (20) lens made in the casing (10d) such that the lens is placed slightly behind the hole (11a) to avoid any lens impact damage; and
a second hole (11b), in the operative middle part (10d), which secures the imaging assembly (20) to the casing (10d).

2. The stump-camera assembly as claimed in claim 1 wherein,
a first axis of said imaging assembly (20) passing through a central axis of said cylindrical casing (10d); and
a second axis of said imaging assembly (20) being perpendicular to said first axis, the second axis being coaxial to said first hole's (11) transverse central axis.

3. The stump-camera assembly as claimed in claim 1 wherein, cylindrical casing (10d) is a metal casing.

4. The stump-camera assembly as claimed in claim 1 wherein, the operative upper part (10a) is 2.5 inches long with a further 1 inch of fastening at its operative bottom that joins with the operative middle metal part (10b) at its operative top.

5. The stump-camera assembly as claimed in claim 1 wherein, the operative middle part (10b) is 10 inches long with a threaded operative top and a threaded operative bottom end to fit the operative top part (10a) and the operative bottom operative part (10c).

6. The stump-camera assembly as claimed in claim 1 wherein, the operative lower part (10c) is 15.5 inches with a further 1 inch of fastening on its operative top that joins the operative middle part (10b) at its operative bottom.

7. The stump-camera assembly as claimed in claim 1 wherein, each part is affixed to the other part by means of threaded couplings (12a, 12b).

8. The stump-camera assembly as claimed in claim 1 wherein, operative middle part (10b) houses the casing (10d) which houses the imaging assembly (20) and the battery/power bank (22).
